(19) United States
(12) Patent Application Publication
(10) Pub. No.: US 2023/0236449 A1
(43) Pub. Date: Jul. 27, 2023

(54) LIQUID CRYSTAL DEVICE COMPRISING AN INTERSTITIAL SUBSTRATE

(71) Applicant: Corning Incorporated, Corning, NY (US)

(72) Inventors: Mingqian He, Horseheads, NY (US); Andrii Varanytsia, Sunnyvale, CA (US)

(21) Appl. No.: 17/918,744

(22) PCT Filed: Apr. 16, 2021
(86) PCT No.: PCT/US2021/027652

§ 371 Date: Oct. 13, 2022

Related U.S. Application Data
(60) Provisional application No. 63/012,543, filed on Apr. 20, 2020.

(51) Int. Cl. G02F 1/1333; G02F 1/1337; G02F 1/1343; G02F 1/1347

(52) U.S. Cl. CPC G02F 1/133302; G02F 1/1337; G02F 1/134309; G02F 1/1347

(57) ABSTRACT

Disclosed are liquid crystal devices including at least two liquid crystal layers, at least one interstitial substrate separating the liquid crystal layers, and at least two alignment layers disposed on opposing surfaces of the interstitial substrate. Also disclosed are liquid crystal windows incorporating said liquid crystal devices.

### CROSS-REFERENCE TO RELATED APPLICATIONS

This application claims the benefit of priority under 35 U.S.C. § of U.S. Provisional Application No. 63/012,543, filed Apr. 20, 2020, the content of which is incorporated herein by reference in its entirety.

### FIELD OF THE DISCLOSURE

The disclosure relates generally to liquid crystal devices comprising at least one interstitial substrate, and more particularly to liquid crystal windows comprising at least two liquid crystal layers separated by an interstitial substrate.

### BACKGROUND

Liquid crystal devices are used in various architectural and transportation applications, such as windows, doors, space partitions, and skylights for buildings and automobiles. For many commercial applications, it is desirable for liquid crystal devices to provide high contrast ratio between the on and off states while also providing good energy efficiency and cost effectiveness. Higher contrast ratio can be achieved using greater amounts of liquid crystal material and/or light absorbing additives. However, as the layer of liquid crystal becomes thicker, it becomes harder to control the orientation of the crystals, which can negatively impact the optical effectiveness and contrast ratio of the overall device. As such, achieving a high contrast ratio using a single liquid crystal cell design has been challenging to date.

Liquid crystal devices including a double cell structure, e.g., two side-by-side liquid crystal cell units, have conventionally been used to obtain desired high contrast ratios. However, double cell structures also have various drawbacks, such as increased overall weight and thickness of the unit and higher manufacturing cost and complexity due to the presence of additional glass layers and electrode components. The additional glass interfaces may also result in optical losses across the double cell structure.

As such, there is a need for lighter and/or thinner liquid crystal devices that provide an acceptable contrast ratio for commercial applications. It would also be advantageous to reduce the cost and complexity of manufacturing such a liquid crystal device. It would further be advantageous to improve the energy efficiency and optical effectiveness of such a liquid crystal device.

### SUMMARY

Disclosed herein are liquid crystal devices comprising first and second glass substrate assemblies, first and second liquid crystal layers, and a third interstitial substrate assembly separating the first and second liquid crystal layers. Also disclosed herein are liquid crystal windows comprising a liquid crystal device as disclosed herein and an additional glass substrate separated from the liquid crystal device by a sealed gap.

The disclosure relates, in various embodiments, to liquid crystal devices comprising: a first substrate assembly comprising a first glass substrate, a first alignment layer, and a first electrode layer disposed therebetween; a second substrate assembly comprising a second glass substrate, a second alignment layer, and a second electrode layer disposed therebetween; a third substrate assembly comprising a third alignment layer, a fourth alignment layer, a third electrode layer, a fourth electrode layer, and a third substrate, wherein the third electrode layer is disposed between the third substrate and the third alignment layer, and wherein the fourth electrode layer is disposed between the third substrate and the fourth alignment layer; a first liquid crystal layer disposed between the first substrate assembly and the third substrate assembly; and a second liquid crystal layer disposed between the second substrate assembly and the third substrate assembly.

In non-limiting embodiments, the first liquid crystal layer can be in direct contact with the first alignment layer and the third alignment layer, and the second liquid crystal layer can be in direct contact with the second alignment layer and the fourth alignment layer. A thickness of the first and second glass substrates may independently range from about 0.1 mm to about 4 mm. The first and second glass substrates may be independently chosen from soda-lime silicate, aluminosilicate, alkali-aluminosilicate, borosilicate, alkaliborosilicate, aluminoborosilicate, and alkali-aluminoborosilicate glasses. According to various embodiments, a thickness of the third substrate can range from about 0.005 mm to about 1 mm. In certain embodiments, the thickness of the third substrate can be substantially equal to the thickness of the first or second liquid crystal layer. The third substrate may, for instance, comprise glass, ceramic, or plastic materials.

In additional embodiments, a thickness of the first, second, third, and fourth electrode layers can independently range from about 1 nm to about 100 nm. The first, second, third, and fourth electrode layers may be independently chosen from transparent conductive oxides, graphene, metal nanowires, carbon nanotubes, and conductive ink layers. In certain embodiments, at least one of the first, second, third, and fourth electrode layers can comprise a pattern, such as a plurality of lines or a plurality of square or rectangular pixels. According to non-limiting embodiments, the first and second electrode layers may be connected to a power source and the third and fourth electrode layers may be electrically linked to one another but not connected to a power source. In additional embodiments, the first and second electrode layers can be connected to a power source, the first and fourth electrode layers may be electrically linked to one another, and the second and third electrode layers may be electrically linked to one another. In further embodiments, the first and second electrode layers may be connected to a first power source and the third and fourth electrode layers may be connected to a second power source.

Further embodiments of the disclosure include first and second liquid crystal layers having a thickness independently ranging from about 0.001 mm to about 0.2 mm. The first and second liquid crystal layers can, for example, comprise achiral nematic liquid crystal, chiral nematic liquid crystal, cholesteric liquid crystal, or smectic liquid crystal. In some embodiments, the liquid crystal layers can optionally further include at least one additional component chosen from dyes, coloring agents, chiral dopants, polymerizable reactive monomers, photoinitiators, and polymerized structures.

Alignment layers can be present in the liquid crystal device and may be in direct contact with the first and/or second liquid crystal layers. A thickness of the alignment layers can independently range from about 1 nm to about 100 nm. Exemplary materials for the alignment layers include, but are not limited to, main chain or side chain polyimides having layer anisotropy, photosensitive azobenzene-based compounds having surface anisotropy, and inorganic thin films having periodic surface microstructures.

Also disclosed herein are liquid crystal devices comprising: a first substrate assembly comprising a first glass substrate, a first electrode layer, and, optionally, a first alignment layer; a second substrate assembly comprising a second glass substrate a second electrode layer, and, optionally, a second alignment layer; a third substrate assembly comprising a third electrode layer, a fourth electrode layer, a third substrate, and, optionally, one or both of a third alignment layer and a fourth alignment layer; a first liquid crystal layer disposed between the first substrate assembly and the third substrate assembly; and a second liquid crystal layer disposed between the second substrate assembly and the third substrate assembly.

Further disclosed herein are liquid crystal devices comprising: a first substrate assembly comprising a first glass substrate, a first alignment layer, and a first electrode layer disposed therebetween; a second substrate assembly comprising a second glass substrate and a second electrode layer; a third substrate assembly comprising a third alignment layer, a third electrode layer, a fourth electrode layer, and a third substrate, wherein the third electrode layer is disposed between the third substrate and the third alignment layer, and wherein the third substrate is disposed between the third electrode layer and the fourth electrode layer; a liquid crystal layer disposed between the first substrate assembly and the third substrate assembly; and an electrochromic layer disposed between the second substrate assembly and the third substrate assembly.

Still further disclosed herein are liquid crystal windows comprising any liquid crystal device of the above embodiments and a glass substrate separated from the liquid crystal device by a sealed gap. The sealed gap may, in various embodiments, contain air, an inert gas, or a mixture thereof.

Additional features and advantages of the disclosure will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and together with the description serve to explain the principles and operations of the various embodiments.

### BRIEF DESCRIPTION OF THE DRAWINGS

The following detailed description can be further understood when read in conjunction with the following drawings. Whenever possible, the same reference numerals will be used throughout the drawings to refer to the same or like parts. It is to be understood that the figures are not drawn to scale and the size of each depicted component or the relative size of one component to another is not intended to be limiting.

FIG. 1 depicts a cross-sectional view of a liquid crystal device according to various embodiments of the disclosure;

FIG. 2 depicts a cross-sectional view of a liquid crystal device according to additional embodiments of the disclosure;

FIG. 3 depicts a cross-sectional view of a liquid crystal device according to further embodiments of the disclosure;

FIG. 4 depicts a cross-sectional view of a liquid crystal device according to still further embodiments of the disclosure;

FIG. 5 depicts a cross-sectional view of a liquid crystal device according to certain embodiments of the disclosure; and

FIG. 6 depicts a cross-sectional view of a liquid crystal window according to non-limiting embodiments of the disclosure.

### DETAILED DESCRIPTION

Disclosed herein are liquid crystal devices comprising: a first substrate assembly comprising a first glass substrate, a first alignment layer, and a first electrode disposed therebetween; a second substrate assembly comprising a second glass substrate, a second alignment layer, and a second electrode disposed therebetween; a third substrate assembly comprising a third alignment layer, a fourth alignment layer, a third electrode layer, a fourth electrode layer, and a third substrate, wherein the third electrode layer is disposed between the third substrate and the third alignment layer, and wherein the fourth electrode layer is disposed between the third substrate and the fourth alignment layer; a first liquid crystal layer disposed between the first substrate assembly and the third substrate assembly; and a second liquid crystal layer disposed between the second substrate assembly and the third substrate assembly.

Also disclosed herein are liquid crystal devices comprising: a first substrate assembly comprising a first glass substrate, a first electrode layer, and, optionally, a first alignment layer; a second substrate assembly comprising a second glass substrate a second electrode layer, and, optionally, a second alignment layer; a third substrate assembly comprising a third electrode layer, a fourth electrode layer, a third substrate, and, optionally, one or both of a third alignment layer and a fourth alignment layer; a first liquid crystal layer disposed between the first substrate assembly and the third substrate assembly; and a second liquid crystal layer disposed between the second substrate assembly and the third substrate assembly.

Further disclosed herein are liquid crystal devices comprising: a first substrate assembly comprising a first glass substrate, a first alignment layer, and a first electrode layer disposed therebetween; a second substrate assembly comprising a second glass substrate and a second electrode layer; a third substrate assembly comprising a third alignment layer, a third electrode layer, a fourth electrode layer, and a third substrate, wherein the third electrode layer is disposed between the third substrate and the third alignment layer, and wherein the third substrate is disposed between the third electrode layer and the fourth electrode layer; a liquid crystal layer disposed between the first substrate assembly and the third substrate assembly; and an electrochromic layer disposed between the second substrate assembly and the third substrate assembly. Still further disclosed herein are liquid crystal windows comprising any liquid crystal device as disclosed herein and a glass substrate separated from the liquid crystal device by a sealed gap.

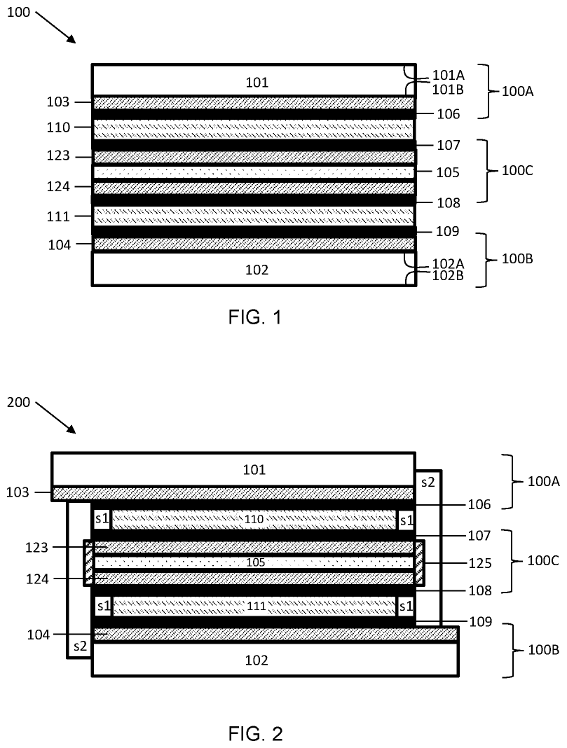

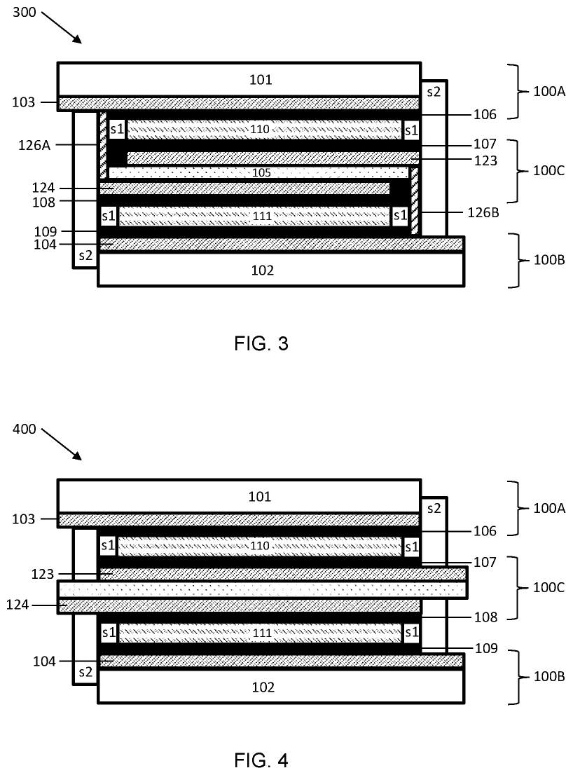

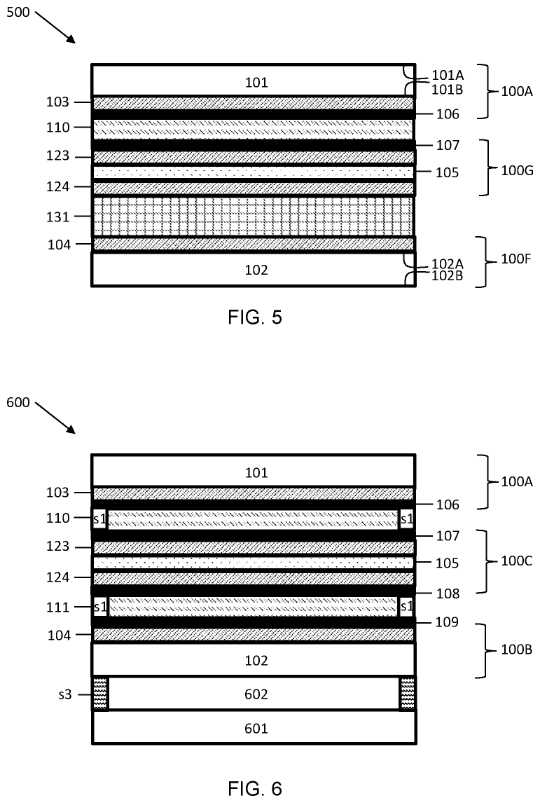

Embodiments of the disclosure will now be discussed with reference to FIGS. 1-6, which illustrate various aspects of the disclosure. FIGS. 1-5 illustrate cross-sectional views of non-limiting embodiments of liquid crystal devices 100 (FIG. 1), 200 (FIG. 2), 300 (FIG. 3), 400 (FIG. 4), and 500 (FIG. 5). FIG. 6 illustrates a cross-sectional view of a non-limiting embodiment of a liquid crystal window. The following general description is intended to provide an overview of the claimed devices, and various aspects will be more specifically discussed throughout the disclosure with reference to the non-limiting depicted embodiments, these embodiments being interchangeable with one another within the context of the disclosure.

Referring to FIG. 1, liquid crystal device 100 includes first and second substrate assemblies 100A, 100B. First substrate assembly 100A comprises a first glass substrate 101 having a first surface 101A and a second surface 101B. A first electrode layer 103 is formed on and/or in direct contact with second surface 101B of first glass substrate 101. The first substrate assembly 100A further includes a first alignment layer 106. The first alignment layer 106 is formed on and/or in direct contact with the first electrode layer 103. The first electrode layer 103 is thus disposed between the first glass substrate 101 and the first alignment layer 106, as depicted in FIG. 1. According to various embodiments, no additional layers are present between the first electrode layer 103 and the first substrate 101 or between the first electrode layer 103 and the first alignment layer 106. In further embodiments, the first substrate assembly 100A consists of the first substrate 101, the first electrode 103, and the first alignment layer 106. The first substrate assembly 100A may be referred to interchangeably herein as an “outer” substrate assembly, the first glass substrate 101 may be referred to herein as an “outer” substrate, and the first electrode layer 103 may be referred to herein as an “outer” electrode.

Similarly, second substrate assembly 100B comprises a second glass substrate 102 having a first surface 102A and a second surface 102B. A second electrode layer 104 is formed on and/or in direct contact with first surface 102A of second glass substrate 102. The second substrate assembly 100B further includes a second alignment layer 109. The second alignment layer 109 is formed on and/or in direct contact with the second electrode layer 104. The second electrode layer 104 is thus disposed between the second glass substrate 102 and the second alignment layer 109, as depicted in FIG. 1. According to various embodiments, no additional layers are present between the second electrode layer 104 and the second substrate 102 or between the second electrode layer 104 and the second alignment layer 109. In further embodiments, the second substrate assembly 100B consists of the second substrate 102, the second electrode 104, and the second alignment layer 109. The second substrate assembly 100B may be referred to interchangeably herein as an “outer” substrate assembly, the second glass substrate 102 may be referred to herein as an “outer” substrate, and the second electrode layer 104 may be referred to herein as an “outer” electrode.

Liquid crystal device 100 also include a third substrate assembly 100C, disposed between the first and second substrate assemblies 100A, 100B. Third substrate assembly 100C comprises a third electrode layer 123, a fourth electrode layer 124, a third alignment layer 107, a fourth alignment layer 108, and a third substrate 105. The third substrate 105 may comprise glass, similar to the first and second substrates 101, 102, or may comprise any other suitable material, such as ceramics or plastics. The third and fourth electrode layers 123, 124 are formed on and/or in direct contact with opposing surfaces of the third substrate 105. The third substrate 105 is thus disposed between the third electrode layer 123 and the fourth electrode layer 124, as depicted in FIG. 1. According to various embodiments, no additional layers are present between the third substrate 105 and the third electrode layer 123 or between the third substrate 105 and the fourth electrode layer 124. The third and fourth alignment layers 107, 108 are formed on and/or in direct contact with the third and fourth electrode layers 123, 124, respectively. The third electrode layer 123 is thus disposed between the third alignment layer 107 and the third substrate 105 and the fourth electrode layer 124 is disposed between the fourth alignment layer 108 and the third substrate 105.

In certain embodiments, no additional layers are present between the third electrode layer 123 and the third alignment layer 107 or between the third electrode layer 123 or the third substrate 105. In further embodiments, no additional layers are present between the fourth electrode layer 124 and the fourth alignment layer 108 or between the fourth electrode layer 124 and the third substrate 105. In still further embodiments, the third substrate assembly 100C consists of the third electrode layer 123, the fourth electrode layer 124, the third alignment layer 107, the fourth alignment layer 108, and the third substrate 105. The third substrate assembly 100C may be referred to interchangeably herein as an “interstitial” substrate assembly, the third substrate 105 may be referred to herein as an “interstitial” substrate, and the third and fourth electrode layers 123, 124 may be referred to herein as an “interstitial” electrodes.

Liquid crystal device 100 further includes first and second liquid crystal layers 110, 111, which are disposed between the first and third substrate assemblies 100A, 100C and the second and third substrate assemblies 100B, 100C, respectively. First liquid crystal layer 110 may be in direct contact with the first alignment layer 106 of the first substrate assembly 100A and in direct contact with the third alignment layer 107 of the third substrate assembly 100C. According to various embodiments, no additional layers are present between the first liquid crystal layer 110 and the first alignment layer 106 or between the first liquid crystal layer 110 and the third alignment layer 107. Similarly, second liquid crystal layer 111 may be in direct contact with the second alignment layer 109 of the second substrate assembly 100B and in direct contact with the fourth alignment layer 108 of the third substrate assembly 100C. In certain embodiments, no additional layers are present between the second liquid crystal layer 111 and the second alignment layer 109 or between the second liquid crystal layer 111 and the fourth alignment layer 108. According to further embodiments, the liquid crystal device may consist of the first substrate assembly 100A, the second substrate assembly 100B, the third substrate assembly 100C, the first liquid crystal layer 110, and the second liquid crystal layer 111.

FIG. 2 illustrates a non-limiting configuration for a liquid crystal device 200. Similar to liquid crystal device 100 of FIG. 1, liquid crystal device 200 includes a first substrate assembly 100A, a second substrate assembly 100B, a third substrate assembly 100C, a first liquid crystal layer 110, and the second liquid crystal layer 111. The orientation of these components and their sub-components relative to one another in device 200 may be the same as that discussed above with reference to device 100. FIG. 2 further illustrates how liquid crystal device 200 may be sealed using first and second seals s1, s2.

First substrate assembly 100A can be produced, for example, by coating, printing, or otherwise depositing the first electrode layer 103 on the second surface 101B of the first substrate 101, and coating, printing, or otherwise depositing the first alignment layer 106 on the first electrode layer 103. Similarly, second substrate assembly 100B can be produced by coating, printing, or otherwise depositing the second electrode layer 104 on the first surface 102A of the second substrate 102, and coating, printing, or otherwise depositing the second alignment layer 109 on the second electrode layer 104. Third substrate assembly 100C can be produced by coating, printing, or otherwise depositing the third and fourth electrode layers 123, 124 on opposing surfaces of the third substrate 105, and coating, printing, or otherwise depositing third and fourth alignment layers 107, 108 on the third and fourth electrode layers 123, 124. These substrates assemblies can then be arranged, with the third substrate assembly 100C between the first and second substrate assemblies 100A and 100C, to form two gaps, which can be filled with liquid crystal material to form liquid crystal layers 110, 111. In some embodiments, spacers (not illustrated) can be used to maintain the desired cell gap and resulting liquid crystal layer thickness. The liquid crystal material can be sealed in the cell gaps around all edges using any suitable material, such as optically or thermally curable resins, to form first seal s1. A second seal s2 can optionally be applied to protect the exposed edges of the substrates and/or electrodes and/or any electrical connections within the device from mechanical impacts and exposure to liquids such as water or condensation.

In some embodiments, as shown in FIG. 2, the first and second electrode layers 103, 104 may be at least partially exposed, e.g., extending outside of seals s1 and s2, to enable electrical connection to a power source (not depicted). FIG. 2 further illustrates one non-limiting configuration for electrically connecting the electrodes within the device 200. In the depicted embodiment, third and fourth electrode layers 123, 124 are electrically linked to one another or “shorted” via connections 125. As such, the interstitial (e.g., third and fourth) electrode layers 123, 124 are not linked to a power source, whereas the outer (e.g., first and second) electrode layers 103, 104 are powered. Without wishing to be bound by theory, it is believed that this embodiment may reduce the driving voltage required for the liquid crystal device 200.

FIG. 3 illustrates a non-limiting configuration for a liquid crystal device 300. Similar to liquid crystal devices 100, 200 of FIGS. 1-2, liquid crystal device 300 includes a first substrate assembly 100A, a second substrate assembly 1008, a third substrate assembly 100C, a first liquid crystal layer 110, and the second liquid crystal layer 111. The orientation of these components and their sub-components relative to one another in device 300 may be the same as that discussed above with reference to device 100. FIG. 3 further illustrates a different configuration for electrically connecting the electrode layers within liquid crystal device 300. In the depicted embodiment, third and fourth electrode layers 123, 124 are electrically linked to first and second electrode layers via connections 126A, 126B. First electrode layer 103 may be linked to fourth electrode layer 124 via connection 126A and second electrode layer 104 may be linked to third electrode layer 123 via connection 126B. As such, interstitial (e.g., third and fourth) electrode layers 123, 124 are linked to opposite outer (e.g., first and second) electrode layers 103, 104, which are connected to a power source (not depicted).

FIG. 4 illustrates a non-limiting configuration for a liquid crystal device 400. Similar to liquid crystal devices 100, 200, 300 of FIGS. 1-3, liquid crystal device $00 includes a first substrate assembly 100A, a second substrate assembly 1008, a third substrate assembly 100C, a first liquid crystal layer 110, and the second liquid crystal layer 111. The orientation of these components and their sub-components relative to one another in device 400 may be the same as that discussed above with reference to device 100. FIG. 4 further illustrates a different configuration for electrically connecting the electrode layers of liquid crystal device 300. In the depicted embodiment, first and second electrode layers 103, 104 are electrically linked to a first power source (not depicted) and the third and fourth electrode layers 123, 124 are separately linked to a second power source (not depicted). As such, interstitial (e.g., third and fourth) electrode layers 123, 124 and outer (e.g., first and second) electrode layers 103, 104 are not electrically linked to each other and may be operated independently from each other.

FIG. 5 illustrates an alternative configuration for a liquid crystal device 500. Similar to liquid crystal device 100 of FIG. 1, liquid crystal device 500 includes a first substrate assembly 100A, a second substrate assembly 100F, a third substrate assembly 100G, and a first liquid crystal layer 110. In the depicted embodiment, electrochromic layer 131 is present between second and third substrate assemblies 100F, 100G, rather than a second liquid crystal layer. Second and fourth alignment layers 108, 109 may be removed from device 500 when it comprises an electrochromic layer 131 in place of a liquid crystal layer. Of course, the depicted configuration is not limiting and the electrochromic layer 131 can be inserted in other locations within device 500, such as replacing first liquid crystal layer 110 (and correspondingly removing first and third alignment layers 106, 107). Electrochromic layer 131 can be controlled by third and fourth electrodes 123, 124 to vary the degree of light transmittance through this layer.

Any suitable electrochromic material can be used in electrochromic layer 131 including lithium ions, electrochromic dyes, and nanocrystals, to name a few. The electrochromic material may undergo chemical and/or physical changes upon application of voltage that affect the attenuation of light. For instance, lithium ions may migrate from the third electrode (e.g., comprising LiCoO₂) to the fourth electrode (e.g., comprising WO₃) through a separator upon application of voltage. Interactions of the lithium ions with the fourth electrode can cause it to reflect light, which may effectively turn the electrode dark/opaque. The lithium ions will remain in that position until the voltage is reversed, causing them to move back to the third electrode and to revert to a bright/clear state. Electrochromic dyes can change colors upon application of voltage, thereby varying the attenuation of light between on and off states. Nanocrystals can similarly allow more or less light to pass through the electrochromic layer depending on the applied voltage. It is also possible to use other electrochromic materials, coatings, and/or assemblies in electrochromic layer 131 without limitation.

Various components of liquid crystal devices 100, 200, 300, 400, and 500 will now be discussed in more detail. According to non-limiting embodiments, at least one of the outer (e.g., first and second) substrates, interstitial (e.g., third and fourth) substrates, electrode layers, and alignment layers may comprise an optically transparent material. As used herein, the term “optically transparent” is intended to denote that the component and/or layer has a transmission of greater than about 80% in the visible region of the spectrum (˜400-700 nm). For instance, an exemplary component or layer may have greater than about 85% transmittance in the visible light range, such as greater than about 90%, or greater than about 95%, including all ranges and subranges therebetween. In certain embodiments, all of the glass substrates, interstitial substrate(s), electrode layers, and alignment layers comprise an optically transparent material.

In non-limiting embodiments, the first and second glass substrates 101, 102 may comprise optically transparent glass sheets. The first and second glass substrates 101, 102 can have any shape and/or size, such as a rectangle, square, or any other suitable shape, including regular and irregular shapes and shapes with one or more curvilinear edges. According to various embodiments, the first and second glass substrates 101, 102 can have a thickness of less than or equal to about 4 mm, for example, ranging from about 0.1 mm to about 4 mm, from about 0.2 mm to about 3 mm, from about 0.3 mm to about 2 mm, from about 0.5 mm to about 1.5 mm, or from about 0.7 mm to about 1 mm, including all ranges and subranges therebetween. In certain embodiments, the glass substrates can have a thickness of less than or equal to 0.5 mm, such as 0.4 mm, 0.3 mm, 0.2 mm, or 0.1 mm, including all ranges and subranges therebetween. In non-limiting embodiments, the glass substrates can have a thickness ranging from about 1 mm to about 3 mm, such as from about 1.5 to about 2 mm, including all ranges and subranges therebetween. First and second glass substrates 101, 102 may, in some embodiments, comprise the same thickness, or may have different thicknesses.

The first and second glass substrates 101, 102 may comprise any glass known in the art, for example, soda-lime silicate, aluminosilicate, alkali-aluminosilicate, borosilicate, alkaliborosilicate, aluminoborosilicate, alkali-aluminoborosilicate, and other suitable display glasses. First and second glass substrates 101, 102 may, in some embodiments, comprise the same glass, or may be different glasses. The glass sheets may, in various embodiments, be chemically strengthened and/or thermally tempered. Non-limiting examples of suitable commercially available glasses include EAGLE XG®, Lotus™, Willow®, and Gorilla® glasses from Corning Incorporated, to name a few. Chemically strengthened glass, for example, may be provided in accordance with U.S. Pat. Nos. 7,666,511, 4,483,700, and 5,674,790, which are incorporated herein by reference in their entireties.

According to various embodiments, the glass substrates may be chosen from glass sheets produced by a fusion draw process. Without wishing to be bound by theory, it is believed that the fusion draw process can provide glass sheets with a relatively low degree of waviness (or high degree of flatness), which may be beneficial for various liquid crystal applications. An exemplary glass substrate may thus, in certain embodiments, comprise a surface waviness of less than about 100 nm as measured with a contact profilometer, such as about 80 nm or less, about 50 nm or less, about 40 nm or less, or about 30 nm or less, including all ranges and subranges therebetween. An exemplary standard technique for measuring waviness (0.8-8 mm) with a contact profilometer is outlined in SEMI D15-1296 “FPD Glass Substrate Surface Waviness Measurement Method.” With reference to FIGS. 1-2, at least one of the first and second surfaces 101A, 101B of first glass substrate 101 and/or at least one of the first and second surfaces 102A, 102B of second glass substrates 102 can, in some embodiments, comprise a surface waviness as described above, e.g., of less than about 100 nm. Similarly, at least one of the opposing major surfaces of third substrate 105 (not labeled) can, in non-limiting embodiments, also comprise a surface waviness of less than about 100 nm.

Third substrate 105, as well as any other interstitial substrates that might be present in the liquid crystal device, can comprise a glass material as discussed above with reference to first and second glass substrates 101, 102. In some embodiments, the outer (e.g., first and second) substrates and the interstitial (e.g., third) substrate may all comprise a glass material, which can be the same or different glass materials. According to other embodiments, the interstitial substrate(s), such as the third substrate 105 may comprise a material other than glass, such as plastics and ceramics, including glass ceramics. Suitable plastic materials include, but are not limited to, polycarbonates, polyacrylates such as polymethylmethacrylate (PMMA), and polyethyelenes such as polyethylene terephthalate (PET). If additional interstitial substrates are present, they may comprise the same material as the third substrate 105, or they may comprise a different material.

The third substrate 105, as well as any other interstitial substrate that might be present in the liquid crystal device, can have any shape and/or size, such as a rectangle, square, or any other suitable shape, including regular and irregular shapes and shapes with one or more curvilinear edges. According to various embodiments, the third substrate 105 can have a thickness of less than or equal to about 4 mm, for example, ranging from about 0.005 mm to about 4 mm, from about 0.01 mm to about 3 mm, from about 0.02 mm to about 2 mm, from about 0.05 mm to about 1.5 mm, from about 0.1 mm to about 1 mm, from about 0.2 mm to about 0.7 mm, or from about 0.3 mm to about 0.5 mm, including all ranges and subranges therebetween. In certain embodiments, the interstitial substrate(s) can have a thickness of less than or equal to 0.5 mm, such as 0.4 mm, 0.3 mm, 0.2 mm, 0.1 mm, 0.05 mm, 0.02 mm, 0.01 mm, or less, including all ranges and subranges therebetween. If additional interstitial substrates are present, they may comprise the same thickness as the third substrate 105, or they may comprise a different thickness.

According to various embodiments, during operation of the liquid crystal device, the opposing surfaces of the interstitial substrate(s), e.g., third substrate 105, may be at the same or substantially the same electrical potential. Without wishing to be bound by theory, it is believed that maintaining a substantially constant electrical potential across the interstitial substrate can reduce the voltage drop across the liquid crystal cell, thereby improving the energy efficiency of the overall device. In certain embodiments, the interstitial substrate(s) may comprise a material with a dielectric constant substantially equal to or greater than the dielectric constant of the liquid crystal material. The liquid crystal dielectric constant can range, in some embodiments, from about 1 to about 100, such as from about 5 to about 90, from about 10 to about 80, from about 15 to about 70, from about 20 to about 60, from about 25 to about 50, or from about 30 to about 40, including all ranges and subranges therebetween. By way of non-limiting example, the dielectric constant of the third substrate 105, and any other interstitial substrates that may be present in the device, may be greater than or equal to about 1, such as greater than or equal to about 5, greater than or equal to about 10, greater than equal to about 20, greater than or equal to about 50, or greater than or equal to about 100, e.g., ranging from about 1 to about 100, such as from about 5 to about 90, from about 10 to about 80, from about 15 to about 70, from about 20 to about 60, from about 25 to about 50, or from about 30 to about 40, including all ranges and subranges therebetween. In various embodiments, the dielectric constant of the third substrate 105 and any other interstitial substrates present in the device can be greater than or equal to about 10.

According to further embodiments, the interstitial substrate(s) may comprise a highly conductive material, for instance, a material having an electrical conductivity of at least about 0⁻⁵ S/m, at least about 10⁻⁴ S/m, at least about 0⁻³ S/m, at least about 10⁻² S/m, at least about 0.1 S/m, at least about 1 S/m, at least about 10 S/m, or at least about 100 S/m, e.g., ranging from 0.0001 S/m to about 1000 S/m, including all ranges and subranges therebetween. A substantially constant electrical potential across the interstitial substrate can also be achieved via configurational changes within the liquid crystal device, for example, by providing shorted electrode layers on either side of the interstitial substrate, as shown in FIG. 2, discussed in more detail above.

The orientation of liquid crystal material can be described by a unit vector, referred to herein as a “director,” which represents the average local orientation of the long molecular axes of the liquid crystal molecules. The substrates in the liquid crystal device can have a surface energy promoting the desired alignment of the liquid crystal director in a ground or “off” state without applied voltage. A vertical or homeotropic alignment is achieved when the liquid crystal director has a perpendicular or substantially perpendicular orientation with respect to the plane of the substrate. A planar or homogeneous alignment is achieved when the liquid crystal director has a parallel or substantially parallel orientation with respect to the plane of the substrate. An oblique alignment is achieved when the liquid crystal direction has a large angle with respect to the plane of the substrate, which is substantially different from planar or homeotropic, i.e., ranging from about 20° to about 70°, such as from about 30° to about 60°, or from about 40° to about 50°, including all ranges and subranges therebetween.

Specific alignment of the liquid crystal can be achieved by coating the surfaces of the substrates and/or electrodes with an alignment layer, for example, alignment layers 106, 107, 108, and 109 as shown in FIGS. 1-5. Alignment layers can comprise a thin film of material having a surface energy and anisotropy promoting the desired orientation for the liquid crystals in direct contact with its surface. Exemplary materials include, but are not limited to, main chain or side chain polyimides, which can be mechanically rubbed to generate layer anisotropy; photosensitive polymers, such as azobenzene-based compounds, which can be exposed to linearly polarized light to generate surface anisotropy; and inorganic thin films, such as silica, which can be deposited using thermal evaporating techniques to form periodic microstructures on the surface. Organic alignment layers promoting vertical or homeotropic orientation of the liquid crystal molecules may be rubbed to create different pretilt angles other than 90° with respect to the plane of the substrate. The pretilt angle of the liquid crystal molecules with respect to the substrate surface will break the symmetry during switching from vertical orientation and can define an azimuthal direction of liquid crystal switching.

Organic alignment layers may be deposited, for example, by spincoating a solution onto a desired surface or using printing techniques. Inorganic alignment layers can be deposited using thermal evaporation techniques. According to various embodiments, the first, second, third, and fourth alignment layers 106, 107, 108, 109, as well as any additional alignment layers that may be present in the device, can have a thickness of less than or equal to about 100 nm, for example, ranging from about 1 nm to about 100 nm, from about 5 nm to about 90 nm, from about 10 nm to about 80 nm, from about 20 nm to about 70 nm, from about 30 nm to about 60 nm, or from about 40 nm to about 50 nm, including all ranges and subranges therebetween. The alignment layers 106, 107, 108, 109 and any other additional alignment layers may, in some embodiments, comprise the same thickness, or may have different thicknesses.

While improved alignment of the liquid crystals can be attained through the use of alignment layers, such alignment layers are not required components for the liquid crystal devices disclosed herein. While FIGS. 1-5 depict an alignment layer in contact with both sides of the liquid crystal layers 110, 111, it is possible to remove one or more of the alignment layers such that no alignment layers are in contact with the liquid crystal layer(s) or only one alignment layer is in contact with the liquid crystal layer. As such, referring to FIG. 1, one or more of alignment layers 106, 107, 108, and 109 may be removed from device 100 without departing from the scope of the disclosure. First substrate assembly 100A can comprise or consist of first substrate 101 and first electrode 103, i.e., without the presence of first alignment layer 106. Similarly, second substrate assembly 1008 can comprise or consist of second substrate 102 and second electrode 104. Third substrate assembly 100C can comprise or consist of third substrate 105, third electrode 123, and fourth electrode 124, alone or in combination with only one of third or fourth alignment layers 107, 108. One or more of alignment layers 106, 107, 108, and 109 can likewise be removed from devices 200, 300, 400, 500 depicted in FIGS. 2-5. The liquid crystal window(s) 600 can be correspondingly modified to remove one or more alignment layers.

The first, second, third, and fourth electrode layers 103, 104, 123, 124 may comprise one or more transparent conductive oxides (TCOs), such as indium tin oxide (ITO), indium zinc oxide (IZO), gallium zinc oxide (GZO), aluminum zinc oxide (AZO), and other like materials. Alternatively, the electrode layers 103, 104, 123, 124 may comprise other transparent materials, such as a conductive mesh, e.g., comprising metals such as silver nanowires or other nanomaterials such as graphene or carbon nanotubes. Printable conductive ink layers such as ActiveGrid™ from C3Nano Inc. may also be used. According to various embodiments, the sheet resistance of the electrode layers 103, 104, 123, 124 can range from about 10Ω/□ (ohms/square) to about 1000Ω/□, such as from about 50Ω/□ to about 900Ω/□, from about 100Ω/□ to about 800Ω/□, from about 200Ω/□ to about 700Ω/□, from about 300Ω/□ to about 600Ω/□, or from about 400Ω/□ to about 500Ω/□, including all ranges and subranges therebetween.

First, second, third, and fourth electrode layers 103, 104, 123, 124 can be fabricated using any technique known in the art, such as vacuum sputtering, film lamination, or printing techniques. With reference to FIGS. 1-5, the first and second electrode layers 103, 104 can be deposited on the second surface 101B of the first glass substrate 101 and the first surface 102A of the second glass substrate 102, respectively. The third and fourth electrode layers 123, 124 can be deposited on opposing surfaces of the third substrate 105. The thickness of each electrode layer can, for example, independently range from about 1 nm to about 1000 nm such as from about 5 nm to about 500 nm, from about 10 nm to about 300 nm, from about 20 nm to about 200 nm, from about 30 nm to about 150 nm, or from about 50 nm to about 100 nm, including all ranges and subranges therebetween.

According to non-limiting embodiments, first and second electrode layers 103, 104 and/or third and fourth electrode layers 123, 124 may include interdigitated electrode layers. Interdigitated electrode layers comprise a pair of electrodes on a single surface that are energized with different voltages. Liquid crystal layer(s) can be controlled by interdigitated electrodes using In Plane Switching (IPS). An electric field starts at the higher voltage interdigitated electrode, travels through any surrounding media (such as an adjacent liquid crystal layer), and terminates at the lower voltage interdigitated electrode. Referring to FIG. 1, electrode layer 103 can comprise interdigitated electrodes on second surface 101B of first substrate 101. An applied electric field can then travel from a high voltage interdigitated electrode on second surface 101B, loop through first liquid crystal layer 110, and end at a low voltage interdigitated electrode on surface 101B. Electrode layer 104 can similarly comprise interdigitated electrodes on first surface 102A of second substrate 102, to which an electric field can be applied to control the alignment of second liquid crystal layer 111. In such an embodiment, third and fourth electrode layers 123, 124 can be removed, which may be advantageous from the standpoint of manufacturing cost and/or complexity. The location of the interdigitated electrode layers may not be limited only to the outer substrate assemblies. Interdigitated electrode layers may also be part of the interstitial substrate assembly. For example, third and fourth electrode layers 123, 124 can comprise interdigitated electrodes and first and second electrode layers 103, 104 can be removed.

In non-limiting embodiments, the first, second, third, and fourth electrode layers 103, 104, 123, 124 can comprise a pattern, such that they produce desired zones or pixels to allow the switching of the entire liquid crystal device or only a desired portion of the device. For instance, the electrode layers 103, 104, 123, 124 can be patterned to form a plurality of lines or stripes having a vertical or horizontal orientation. Such a pattern can be used to configure, e.g., window transmission similar to mechanical shades by turning on alternating stripes or by setting adjacent electrode stripes to different transmission intensities. Alternative patterns are possible and envisioned as falling within the scope of this disclosure, such as a matrix of square or rectangular pixels, which can be used to configure, e.g., window transmission to provide an arbitrary pattern. The width of the patterned lines and/or pixels can range, in various embodiments, from about 1 mm to about 500 mm, such as from about 2 mm to about 400 mm, from about 3 mm to about 300 mm, from about 5 mm to about 200 mm, from about 10 mm to about 100 mm, or from about 20 mm to about 50 mm, including all ranges and subranges therebetween.

As discussed above with respect to FIGS. 1-4, the electrode layers 103, 104, 123, 124 may be electrically linked or paired in various configurations. In a powered “on” state, external voltage applied across one or both electrode pairs generates one or more electric fields within the device that can be used to realign the orientation of the liquid crystals in the device. Additive molecules dissolved in the liquid crystal mixture or otherwise combined with the liquid crystals typically follow the same orientation as the liquid crystals. In an “off” state, the liquid crystals and any additive molecules within the cell will be aligned in an orientation with the smallest amount of free energy. Such a state may be defined by an anchoring force acting on the liquid crystals, e.g., by the alignment layer(s). Voltage applied to the electrodes thus allows the user to change the orientation of the liquid crystals and additive molecules to control the degree of attenuation of light passing through the liquid crystal layer. In a bright/clear state, the geometry and choice of liquid crystal can be chosen to provide equal or substantially equal transmittance to all polarizations of light incident on the cell. Similarly, in a dark/opaque state, the geometry and choice of liquid crystal can provide equal or substantially equal attenuation to all polarizations of light incident on the cell.

Liquid crystal devices 100, 200, 300, and 400 can include two or more liquid crystal layers, such as first liquid crystal layer 110 and second liquid crystal layer 111. Additional liquid crystal layers may also be present in the device. A liquid crystal layer can comprise liquid crystals and one or more additional components, such as dyes or other coloring agents, chiral dopants, polymerizable reactive monomers, photoinitiators, polymerized structures, or any combination thereof. The liquid crystals can have any liquid crystal phase, such as achiral nematic liquid crystal (NLC), chiral nematic liquid crystal, cholesteric liquid crystal (CLC), or smectic liquid crystal, which are operable over a broad range of temperatures, such as from about −40° C. to about 100° C.

According to various embodiments, the liquid crystal layers 110, 111, can comprise a cell gap or cavity that is filled with liquid crystal material. The thickness of the liquid crystal layer, or the cell gap distance, can be maintained by particle spacers and/or columnar spacers dispersed in the liquid crystal layer. The first and second liquid crystal layers 110, 111, as well as any additional liquid crystal layers, can have a thickness of less than or equal to about 0.2 mm, for example, ranging from about 0.001 mm to about 0.1 mm, from about 0.002 mm to about 0.05 mm, from about 0.003 mm to about 0.04 mm, from about 0.004 mm to about 0.03 mm, from about 0.005 mm to about 0.02 mm, or from about 0.01 mm to about 0.015 mm, including all ranges and subranges therebetween. The first and second liquid crystal layers 110, 111 and any other liquid crystal layers present in the device may, in some embodiments, comprise the same thickness, or may have different thicknesses.

Any liquid crystal switching mode known in the art can be used, such as a TN (twisted nematic) mode, a VA (vertically aligned) mode, an IPS (in plane switching) mode, a BP (blue phase) mode, a FFS (Fringe Field Switching) mode, and an ADS (Advanced Super Dimension Switch) mode, to name a few. An analog switching mode may be desirable in certain embodiments, in which gradual changes in the magnitude of voltage applied to the electrodes allows for variation in transmitted light intensity levels to achieve a gray scale effect. The liquid crystal device may also function in a binary switching mode with only two available light intensity transmission levels—bright/clear (high light transmission) and dark/opaque (low light transmission). One potential advantage for binary mode switching is the ability to function in a bistable fashion, such that electrical power is consumed only during switching between on and off states and is not consumed once these states are reached.

Referring to FIG. 4, a liquid crystal device 400 comprising two liquid crystal layers 110, 111 and two independently operable electrode pairs (e.g., 103, 104 and 123, 124) can allow for three stable optical states. Each bistable liquid crystal layer can be independently switched to a bright/clear state or dark/opaque state. In the first optical state, both the first and second liquid crystal layers 110, 111 are switched to a bright/clear state. In the second optical state, both the first and second liquid crystal layers 110, 111 are switched to a dark/opaque state. In the third optical state, one of the first or second electrode layers 110, 111 is switched to the clear state and the other is switched to the dark/opaque state.

In some embodiments, dyes or other coloring agents, such as dichroic dyes, can be added to one or more of the liquid crystal layers 110, 111, to absorb light transmitted through the liquid crystal layer(s). Dichroic dyes typically absorb light more strongly along a direction parallel to the direction of a transition dipole moment in the dye molecule, which is typically the longer molecular axis of the dye molecule. Dye molecules oriented with their long axis perpendicular to the direction of light polarization will provide low light attenuation, whereas dye molecules oriented with their long axis parallel to the direction of light polarization will provide strong light attenuation.

A normally bright/clear liquid crystal device with the highest light transmission in the “off” state can, in various embodiments, be achieved by using a homeotropic alignment and a liquid crystal layer comprising liquid crystals with negative dielectric anisotropy and additive dye molecules. In this configuration, the dye molecules will be aligned in a low-absorbing perpendicular orientation in the powered “off” state and will be rotated with the liquid crystals to a highly-absorbing parallel orientation in the powered “on” state. Similarly, a normally dark/opaque liquid crystal device with the highest light transmission in the “on” state can, in certain embodiments, be achieved by using a planar alignment and a liquid crystal layer comprising liquid crystals with positive dielectric anisotropy and additive dye molecules. In this configuration, the dye molecules will be aligned in a highly-absorbing parallel orientation in the powered “off” state and will be rotated with the liquid crystals to a low-absorbing perpendicular orientation in the powered “on” state.

Generally, both normally bright/clear and normally dark/opaque liquid crystal devices function in a haze-free or low-haze fashion such that an observer can see through the liquid crystal device with little to no distortion. However, in certain instances, it may be desirable to provide the liquid crystal device with a “privacy” mode such that the image an observer can see through the liquid crystal device is darkened or diffused. Such a privacy mode can be achieved, e.g., by providing a light scattering effect to trap light within the liquid crystal layer such that the amount of light absorbed by the dye is increased.

Light scattering effects within the liquid crystal layer can be achieved in several different ways that promote or enhance the random alignment of liquid crystals. One or more chiral dopants may be added to the liquid crystal mixture to form highly twisted cholesteric liquid crystals (CLC), which may have a random alignment that provides light scattering effects, referred to herein as a focal conic texture. Random liquid crystal alignment can also be promoted or assisted by including polymer structures, such as polymer fibers, in the matrix of the liquid crystal layer, referred to herein as polymer stabilized cholesteric texture (PSCT). Random liquid crystal alignment can also be achieved using small droplets of nematic liquid crystal (without a chiral dopant) randomly dispersed in a solid polymer layer or a dense network of polymer fibers, or polymer walls, referred to herein as polymer dispersed liquid crystal (PDLC).

According to various embodiments, polymers may be dispersed in the matrix of the liquid crystal layer or on the interior surfaces of the glass and interstitial substrates. Such polymers may be formed by polymerization of monomers dissolved in the liquid crystal mixture. In certain embodiments, polymer protrusions or other polymerized structures may be formed on the interior surfaces of the outer substrates and/or interstitial substrates, such as in a normally clear liquid crystal device with homeotropic alignment layer(s), to define an azimuthal switching direction and to improve electro-optic switching speed.

As noted above, chiral dopants may be added to the liquid crystal mixture to achieve a twisted supramolecular structure of liquid crystal molecules, referred to herein as cholesteric liquid crystal (CLC). The amount of twist in the CLC is described by a helical pitch which represents the rotation angle of a local liquid crystal director by 360 degrees across the cell gap thickness. CLC twist can also be quantified by a ratio (d/p) of cell gap thickness (d) to CLC helical pitch (p). For liquid crystal applications, the amount of chiral dopant dissolved in the liquid crystal mixture can be controlled to achieve a desired amount of twist across a given cell gap distance. It is within the ability of one skilled in the art to select the appropriate dopant and its amount to achieve the desired twisted effect.

In various embodiments, the liquid crystal layers disclosed herein may have an amount of twist ranging from about 0° to about 25×360° (or d/p ranging from about 0 to about 25.0), for example, ranging from about 45° to about 1080° (d/p from about 0.125 to about 3), from about 90° to about 720° (d/p from about 0.25 to about 2), from about 180° to about 540° (d/p from about 0.5 to about 1.5), or from about 270° to about 360° (d/p from about 0.5 to about 1), including all ranges and subranges therebetween. As used herein, a liquid crystal mixture that does not include chiral dopants is referred to as a nematic liquid crystal (NLC). A liquid crystal that includes a chiral dopant and has a small pitch and a large twist refers to a CLC mixture wherein d/p is greater than 1. A liquid crystal that includes a chiral dopant and has a large pitch and a small twist refers to a CLC mixture wherein d/p is less than or equal to 1.

As discussed above, dichroic dyes absorb light more strongly when the long axis of the dye molecules is oriented parallel to the direction of polarized light. Thus, devices comprising nematic liquid crystal layers perform best in cases where there is only one linear polarization of light. However, in certain commercial applications, such as automotive glazings, the light passing through the liquid crystal device is unpolarized. In such instances, it may be advantageous to provide a liquid crystal device comprising two or more liquid crystal layers comprising nematic liquid crystals, and to position the liquid crystal layers with orthogonal orientations (e.g., rotated by 90°) relative to each other to efficiently attenuate the unpolarized light. Alternatively, attenuation of unpolarized light can be achieved using a liquid crystal device comprising two or more liquid crystal layers comprising twisted CLC liquid crystals. For instance, when at least 90° of twist is provided by the CLC across the cell gap thickness, the molecules of dye can absorb substantially all linearly polarized components of the unpolarized light.

In the case of planar or homogeneous alignment, in the “off” state a twisted CLC structure will align the dye molecules in a parallel or horizontal orientation, thereby creating a dark/opaque state with minimum light transmission. In the “on” state, the liquid crystal layer will be realigned by the applied electric field to a perpendicular or vertical orientation, thereby creating a bright/clear state with maximum light transmission. Similarly, in the case of vertical or homeotropic alignment, in the “off” state a twisted CLC structure will be suppressed by the alignment layers on either side of the liquid crystal layer, which causes the dye molecules to align in a perpendicular/vertical orientation, thereby creating a bright/clear state with maximum light transmission. In the “on” state, the liquid crystal layer will be realigned by the applied electric field to a parallel/horizontal orientation, thereby creating a dark/opaque state with minimum light transmission.

It is to be understood that the scope of the disclosure is not limited solely to the embodiments depicted in FIGS. 1-5. The liquid crystal devices disclosed herein can comprise additional liquid crystal layers, additional interstitial substrates, additional alignment layers, and/or additional electrode layers, which may be the same or different and may be combined in any suitable manner without limitation. The individual liquid crystal layers in the device may comprise the same or different liquid crystal materials and/or additives, the same or different thicknesses, the same or different switching modes, and the same or different orientations relative to one another. If more than one interstitial substrate is present within the device, the interstitial substrates may comprise the same or different materials and the same or different thicknesses. Similarly, the individual alignment layers in the device may comprise the same or different materials, the same or different thicknesses, and the same or different orientations relative to one another. Likewise, the individual electrode layers in the device may comprise the same or different materials, the same or different thicknesses, and the same or different patterns.

In certain embodiments, optical effects from a liquid crystal structure can be amplified by assembling the liquid crystal device with alignment layers at specific orientations with respect to each other. For example, the axes of the different alignment layers, which may be defined, e.g., by the direction of rubbing, may be parallel to one another, antiparallel to one another, rotated by 90° with respect to each other, or rotated by another angle relative to each other. Referring to FIGS. 1-4, first and third alignment layers 106, 107 and first liquid crystal layer 110 may produce a first liquid crystal director in the “off” state, whereas fourth and second alignment layers 108, 109 and second liquid crystal layer 111 may produce a second liquid crystal director in the “off” state that is different from the first liquid crystal director.

The liquid crystal devices disclosed herein can be used in various architectural and transportation applications. For example, the liquid crystal devices can be used as liquid crystal windows that can be included in doors, space partitions, skylights, and windows for buildings, automobiles, and other transportation vehicles such as trains, planes, boats, and the like. Referring to FIG. 6, a liquid crystal window 600 may, in some embodiments, comprise an additional glass substrate 601, which is separated from the liquid crystal device 100 by a gap 602. The additional glass substrate 601 can comprise any suitable glass material having any desired thickness, including those discussed above with respect to first and second glass substrates 101, 102. The gap 602 can be sealed, e.g., by third seal s3, and filled with air, an inert gas, or a mixture thereof, which may improve the thermal performance of the liquid crystal window. Suitable inert glasses include, but are not limited to, argon, krypton, xenon, and combinations thereof. Mixtures of inert gases or mixtures of one or more inert gases with air can also be used. Exemplary non-limiting inert gas mixtures include 90/10 or 95/5 argon/air, 95/5 krypton/air, or 22/66/12 argon/krypton/air mixtures. Other ratios of inert gases or inert gases and air can also be used depending on the desired thermal performance and/or end use of the liquid crystal window.

In various embodiments, the glass substrate 601 is an interior pane, e.g., facing the interior of the building or vehicle, although the opposite orientation, with glass 601 facing the exterior, is also possible. Liquid crystal window devices for use in architectural applications can have any desired dimension including, but not limited to 2′×4′ (width×height), 3′×5′, 5′×8′, 6′×8′, 7×10′, or 7′×12′. Larger and smaller liquid crystal windows are also envisioned and are intended to fall within the scope of this disclosure. Although not illustrated, it is to be understood that the liquid crystal device 600 can comprise one or more additional components such as a frame or other structural component, a power source, and/or a control device or system. It is also to be understood that while FIG. 6 illustrates a liquid crystal window 600 comprising the liquid crystal device 100 of FIG. 1, any of the liquid crystal devices depicted and/or described herein can also be used in a liquid crystal window application.

The liquid crystal devices and windows disclosed herein may have various advantages as compared to prior art devices. For instance, the liquid crystal devices may have a high contrast ratio comparable to that of traditional double cell devices, but with a thinner and/or lighter profile due to the use of less glass in the overall structure. In certain embodiments, the contrast ratio of the liquid crystal devices disclosed herein can be greater than or equal to 1:20, such as greater than 1:30, greater than 1:40, or greater than 1:50, including all ranges and subranges therebetween. Visible light transmission in the dark/opaque state may be about 3% or less, such as about 2% or less, or about 1% or less, including all ranges or subranges therebetween, while light transmission in the bright/clear state may be about 70% or greater, such as about 80% or greater, or about 90 or greater, including all ranges and subranges therebetween. Optical losses may also be minimized due to the reduction in glass interfaces within the device. According to various embodiments, the liquid crystal devices disclosed herein may have a low haze value, such as less than about 1%, less than about 0.5%, or less than about 0.1%, including all ranges and subranges therebetween.

While a traditional double cell device comprises four panes of glass, two for each liquid crystal cell, the liquid crystal devices disclosed herein can comprise as few as three substrates, e.g., the first and second (outer) glass substrates and the third (interstitial) glass substrate. Additionally, because the interstitial substrate is not critical in terms of structural stability of the overall device, this substrate can, in some embodiments, have a relatively low thickness as compared to the outer substrates. Thus, even in embodiments where more than one interstitial substrate is present, the overall thickness and/or weight of the device may still be considerably lower than that of a double cell device. Manufacturing complexity and/or cost may also be reduced due to a decrease in the number of components, such as glass substrates.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a device that comprises A+B+C include embodiments where a device consists of A+B+C and embodiments where a device consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

1. A liquid crystal device comprising:
(a) a first substrate assembly comprising a first glass substrate, a first alignment layer, and a first electrode layer disposed therebetween;
(b) a second substrate assembly comprising a second glass substrate, a second alignment layer, and a second electrode layer disposed therebetween;
(c) a third substrate assembly comprising a third alignment layer, a fourth alignment layer, a third electrode layer, a fourth electrode layer, and a third substrate, wherein the third electrode layer is disposed between the third substrate and the third alignment layer, and wherein the fourth electrode layer is disposed between the third substrate and the fourth alignment layer;
(d) a first liquid crystal layer disposed between the first substrate assembly and the third substrate assembly; and
(e) a second liquid crystal layer disposed between the second substrate assembly and the third substrate assembly.

2. The liquid crystal device of claim 1, wherein the first liquid crystal layer is in direct contact with the first alignment layer and the third alignment layer, and wherein the second liquid crystal layer is in direct contact with the second alignment layer and the fourth alignment layer.

3. The liquid crystal device of claim 1, wherein a thickness of the first and second glass substrates independently ranges from 0.1 mm to 4 mm.

4. The liquid crystal device of claim 1, wherein the first and second glass substrates are independently chosen from soda-lime silicate, aluminosilicate, alkali-aluminosilicate, borosilicate, alkaliborosilicate, aluminoborosilicate, and alkali-aluminoborosilicate glasses.

5. The liquid crystal device of claim 1, wherein the third substrate is chosen from glass, ceramic, or plastic substrates.

6. The liquid crystal device of claim 1, wherein a thickness of the third substrate ranges from 0.005 mm to 1 mm.

7. The liquid crystal device of claim 1, wherein a thickness of the third substrate is substantially equal to a thickness of the first or second liquid crystal layers.

8. The liquid crystal device of claim 1, wherein a thickness of the first, second, third, and fourth electrode layers independently ranges from 1 nm to 100 nm.

9. The liquid crystal device of claim 1, wherein the first, second, third, and fourth electrode layers are independently chosen from transparent conductive oxides, graphene, metal nanowires, carbon nanotubes, and conductive ink layers.

10. The liquid crystal device of claim 1, wherein at least one of the first, second, third, and fourth electrode layers comprises a pattern.

11. The liquid crystal device of claim 10, wherein the pattern comprises a plurality of lines, a plurality of square pixels, or a plurality of rectangular pixels.

12. The liquid crystal device of claim 1, wherein the first and second electrode layers are connected to a power source, wherein the third and fourth electrode layers are not connected to a power source, and wherein the third electrode layer is electrically linked to the fourth electrode layer.

13. The liquid crystal device of claim 1, wherein the first and second electrode layers are connected to a power source, wherein the first electrode layer is electrically linked to the fourth electrode layer, and wherein the second electrode layer is electrically linked to the third electrode layer.

14. The liquid crystal device of claim 1, wherein the first and second electrode layers are connected to a first power source, and wherein the third and fourth electrode layers are connected to a second power source.

15. The liquid crystal device of claim 1, wherein a thickness of the first and second liquid crystal layers independently ranges from 0.001 mm to 0.2 mm.

16. The liquid crystal device of claim 1, wherein the first and second liquid crystal layers are independently chosen from achiral nematic liquid crystal, chiral nematic liquid crystal, cholesteric liquid crystal, and smectic liquid crystal.

17. The liquid crystal device of claim 1, wherein the first and second liquid crystal layers further comprise at least one additional component chosen from dyes, coloring agents, chiral dopants, polymerizable reactive monomers, photoinitiators, and polymerized structures.

18. The liquid crystal device of claim 1, wherein a thickness of the first, second, third, and fourth alignment layers independently ranges from 1 nm to 100 nm.

19. The liquid crystal device of claim 1, wherein the first, second, third, and fourth alignment layers comprise at least one material chosen from main chain or side chain polyimides having layer anisotropy, photosensitive azobenzene-based compounds having surface anisotropy, and inorganic films having periodic surface microstructures.

20. The liquid crystal device of claim 1, wherein the device has a haze value of less than 1%.

21.-23. (canceled)
